(19) United States
(12) Patent Application Publication
(10) Pub. No.: US 2026/0084723 A1
(43) Pub. Date: Mar. 26, 2026

(54) VEHICLE CONTROL SYSTEM

(71) Applicant: TOYOTA JIDOSHA KABUSHIKIKAISHA, Toyota-shi (JP)

(72) Inventors: Yuki OKAMOTO, Ebina-shi (JP); Go INOUE, Gotenba-shi (JP); Noritsugu IWAZAKI, Shizuoka-ken (JP); Yuhei OKA, Shizuoka-ken (JP); Daisuke KAKUMA, Shizuoka-ken (JP); Hiroya CHIBA, Shizuoka-ken (JP); Takeshi KANOU, Seto-shi (JP); Kento OHARA, Nisshin-shi (JP)

(73) Assignee: TOYOTA JIDOSHA KABUSHIKIKAISHA, Toyota-shi (JP)

(21) Appl. No.: 19/259,590

(22) Filed: Jul. 3, 2025

(30) Foreign Application Priority Data
Sep. 25, 2024 (JP) 2024-166343

(51) Int. Cl. B60W 60/00; B60W 50/06; G01M 17/007

(52) U.S. Cl. CPC B60W 60/0025; B60W 50/06; G01M 17/0074; B60W 2720/10

(57) ABSTRACT

A vehicle control system according to the present disclosure is a vehicle control system that causes a vehicle to self-propel to a drum tester and controls an operation of a vehicle on the drum tester. A first detection unit for detecting that the target vehicle has reached the drum tester, a second detection unit for detecting lateral movement information on the drum tester of the target vehicle, and a controller for controlling the travel to the drum tester and the operation on the drum tester of the target vehicle. After the arrival of the target vehicle to the drum tester is detected by the first detection unit, the controller controls the operation of the target vehicle on the drum tester based on the movement information detected by the second detection unit.

### CROSS-REFERENCE TO RELATED APPLICATION

This application claims priority to Japanese Patent Application No. 2024-166343 filed on Sep. 25, 2024. The disclosure of the above-identified application, including the specification, drawings, and claims, is incorporated by reference herein in its entirety.

### BACKGROUND

### 1. Technical Field

The present disclosure relates to a vehicle control system.

### 2. Description of Related Art

There is known a technology (autonomous conveyance technology) in which, when a vehicle is manufactured, the vehicle is conveyed by being caused to autonomously travel through autonomous control or remote control, rather than the vehicle is conveyed by a conveyor, for example, as disclosed in Japanese Patent No. 7424535 (JP 7424535 B), for example.

### SUMMARY

The inventors have studied to cause a vehicle to travel without human attendance also in an inspection process for finished vehicles. In normal travel, the operation of a vehicle is controlled while estimating the position of the vehicle based on the vehicle speed. Here, on a drum tester, a vehicle does not travel even when wheels are driven, and therefore the operation of the vehicle cannot be controlled based on the vehicle speed. Therefore, when the same control as the normal travel is performed on the vehicle on the drum tester, the operation of the vehicle cannot be appropriately controlled when the vehicle slides laterally on the drum tester, for example.

The present disclosure has been made in view of such circumstances, and provides a vehicle control system capable of appropriately controlling the operation of a vehicle on a drum tester.

An aspect of the present disclosure provides a vehicle control system that causes a vehicle to travel autonomously to a drum tester and controls operation of the vehicle on the drum tester, the vehicle control system including:
a first detection unit that detects that a target vehicle has reached the drum tester;
a second detection unit that detects movement information on lateral movement of the target vehicle on the drum tester; and
a controller that controls travel of the target vehicle to the drum tester and operation of the target vehicle on the drum tester, in which
the controller controls the operation of the target vehicle on the drum tester based on the movement information detected by the second detection unit after the first detection unit detects that the target vehicle has reached the drum tester.

In the vehicle control system according to the aspect of the present disclosure, the operation of the vehicle on the drum tester is controlled based on position information on the lateral position of the target vehicle on the drum tester detected by the second detection unit after the first detection unit detects that the target vehicle has reached the drum tester. Since the operation of the vehicle on the drum tester is mainly limited to lateral slide, the operation of the vehicle on the drum tester can be appropriately controlled by detecting the movement information on the lateral movement of the vehicle on the drum tester.

According to the aspect of the present disclosure, it is possible to provide a vehicle control system capable of appropriately controlling the operation of a vehicle on a drum tester.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating a part of a vehicle control system according to a first embodiment;

FIG. 2 is a block diagram illustrating a control system of the vehicle control system according to the first embodiment;

FIG. 3 is a diagram for explaining travel control of a vehicle;

FIG. 4 is a control block diagram for explaining the travel control example 1;

FIG. 5 is a flowchart for explaining the travel control example 1;

FIG. 6 is a control block diagram for explaining a travel control example 2; and FIG. 7 is a flowchart for explaining the travel control example 2.

### DETAILED DESCRIPTION OF EMBODIMENTS

Hereinafter, a specific embodiment to which the disclosure is applied will be described in detail with reference to the drawings. However, the disclosure is not limited to the following embodiment. The following description and drawings are simplified as appropriate for the sake of clarity.

### First Embodiment

### Overview of Vehicle Control System

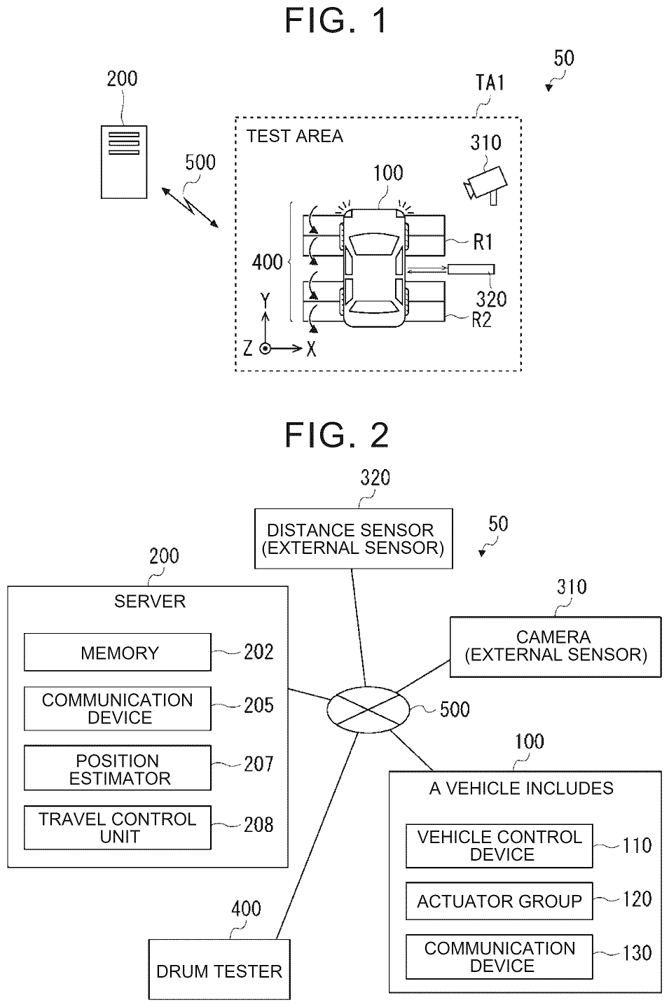

First, an outline of a vehicle control system will be described with reference to FIG. 1. FIG. 1 is a schematic diagram illustrating a part of a vehicle control system according to a first embodiment. The vehicle control system 50 is applied, for example, in a vehicle manufacturing factory that manufactures the vehicle 100. In the embodiment of FIG. 1, the vehicle control system 50 controls the running test of the vehicle 100 disposed on the roller of the drum tester 400 in the test area TA1.

As shown in FIG. 1, a vehicle control system (also referred to simply as a system) 50 includes a server 200, a camera 310, a distance sensor 320, and a drum tester 400. The vehicle 100 is a self-propelled vehicle capable of self-propelling during a manufacturing process. In other words, the vehicle 100 is a vehicle that can be moved by unmanned driving during a manufacturing process.

The right-hand system XYZ Cartesian coordinates illustrated in FIG. 1 are for convenience of describing the positional relation of the constituent elements. In FIG. 1 and the like, for example, the Z-axis positive direction is a vertical upward direction, and XY plane is a horizontal plane, which is the same among the drawings.

The drum tester 400 has a pair of rollers R1 that supports the front wheels of the vehicle 100 and a pair of rollers R2 that supports the rear wheels of the vehicle 100. In the drum tester 400, the rollers R1, R2 rotate as the wheels of the vehicle 100 rotate, so that the vehicle 100 is caused to travel on the drum tester 400 under various travel conditions.

The camera 310 is a form of the external sensor 300 and captures a test area TA1 in which the drum tester 400 is installed. The camera 310 is a first detection unit that detects the arrival of the vehicle 100 to be controlled to the drum tester 400. The camera 310 has a communication function and transmits data such as captured images to the server 200 via the network 500.

The distance sensor 320 is one form of the external sensor 300 and is a second detection unit that detects position information, i.e., movement information, of the vehicle 100 on the drum tester 400 in the lateral direction (the lateral direction, i.e., the X-axis direction). The distance sensor 320 has a communication function and transmits lateral position information of the vehicle 100 to the server 200 via the network 500.

The distance sensor 320, which is a second detection unit, may also serve as a first detection unit that detects the arrival of the vehicle 100 to the drum tester 400. Also in this case, for example, the camera 310 is used for control for causing the vehicle 100 to self-propel to the drum tester 400. In addition to the distance sensor 320 as the second detection unit shown in FIG. 1, a distance sensor 320 (not shown) may be provided as a third detection unit that detects position information, that is, movement information, of the vehicle 100 on the drum tester 400 in the front-rear direction (Y-axis direction).

On the other hand, the camera 310 may be provided directly above the drum tester 400, and may also serve as a second detection unit that detects position information in the lateral direction of the vehicle 100 and a third detection unit that detects position information in the longitudinal direction. In this case, the distance sensor 320 is not required.

The server 200 controls the traveling of the vehicle 100 and the operation on the drum tester 400 while estimating the position of the vehicle 100 based on the captured image of the vehicle 100 received from the camera 310 and the position information of the vehicle 100 on the drum tester 400 received from the distance sensor 320. That is, the server 200 has a function as a controller that causes the vehicle 100 to self-propel to the drum tester 400 and controls the operation of the vehicle 100 on the drum tester 400. Details of the operation control of the vehicle 100 by the server 200 will be described later.

### Details of Control in Vehicle Control System

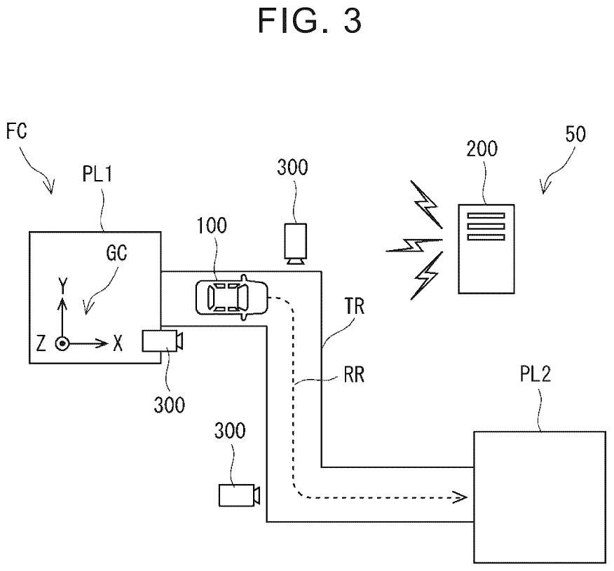

Next, the details of the control in the vehicle control system will be described with reference to FIG. 2. FIG. 2 is a block diagram illustrating a control system of the vehicle control system according to the first embodiment. As illustrated in FIG. 2, the server 200 includes a memory 202, a communication device 205, a position estimation unit 207, and a travel control unit 208. The vehicle 100 includes a vehicle control device 110, an actuator group 120, and a communication device 130. Note that the server 200 may be configured not only by a single device physically but also by a plurality of distributed devices.

In the server 200, the communication device 205 communicates with the camera 310, the distance sensor 320, the drum tester 400, and the vehicle 100 via the network 500. For example, the communication device 205 receives data such as a captured image of the vehicle 100 from the camera 310, and receives position information of the vehicle 100 on the drum tester 400 from the distance sensor 320. In addition, the communication device 205 receives information related to the rotational state of the rollers R1, R2 from the drum tester 400. Further, the communication device 205 transmits, for example, information related to vehicle control based on the traveling condition of the traveling test to the vehicle 100, and receives information related to the test result such as the speed indicated by the speedometer from the vehicle 100.

The position estimation unit 207 estimates the position of the vehicle 100 on the basis of an image of the vehicle 100 captured by the camera 310 or another camera (not shown) while the vehicle 100 travels to the drum tester 400. Specifically, the communication device 205 receives data such as a captured image from the camera 310 or another camera, and the position estimation unit 207 estimates the position of the vehicle 100 by analyzing the received captured image (that is, image analysis). Note that the number of cameras 310 that photograph the vehicle on the drum tester 400 may be one or more.

On the other hand, after the vehicle 100 arrives at the drum tester 400, the position estimation unit 207 estimates the position of the vehicle 100 based on the position information of the vehicle 100 on the drum tester 400 acquired by the distance sensor 320.

Here, the operation of the vehicle 100 on the drum tester 400 is mainly limited to the sliding in the lateral direction (X-axis direction). Therefore, by detecting lateral movement information of the vehicle 100 on the drum tester 400, the operation of the vehicle 100 on the drum tester 400 can be appropriately controlled.

Further, by using the distance sensor 320 instead of the camera 310 in order to detect the movement information, the position estimation unit 207 can estimate the position of the vehicle 100 without performing image analysis. As a result, the processing speed of the position estimation can be increased.

When the camera 310 also serves as the second detection unit without using the distance sensor 320, the position estimation unit 207 can estimate the left-right position of the vehicle 100 on the drum tester 400 based on the positional relation between the rollers R1, R2 of the drum tester 400 and the vehicle 100, which is specified from the captured image of the camera 310.

The travel control unit 208 controls the travel of the vehicle 100 and the operation on the drum tester 400 based on the position of the vehicle 100 estimated by the position estimation unit 207. The travel control unit 208 controls the vehicle 100 on the drum tester 400 so that the vehicle 100 travels stably on the rotating rollers R1, R2.

Here, on the drum tester 400, the wheels of the vehicle 100 are rotationally driven in accordance with the travel test, and the rollers R1, R2 rotate accordingly. At this time, it is preferable that the wheels of the vehicles 100 remain on the rollers R1, R2 and do not move in the left-right direction (X-axis direction) and the front-rear direction (Y-axis direction).

Therefore, the travel control unit 208 adjusts the operation of the vehicle 100 in the lateral direction (left-right direction) based on the position of the vehicle 100 estimated by the position estimation unit 207 so that, for example, the vehicle 100 falls within a range of a predetermined reference area on the drum tester 400.

Specifically, when the wheels of the vehicle 100 on the drum tester 400 slide in, for example, the X-axis positive direction on the rotating rollers R1, R2, the travel control unit 208 controls the amount of change in the movement of the vehicle 100 in the left-right direction and the rate of change in the movement so that the wheels of the vehicle 100 slide in the opposite direction (X-axis negative direction). Movement of the vehicle 100 in the left-right direction is caused by a steering operation. Therefore, specifically, the travel control unit 208 controls the steering angle (deg) and the steering angle change rate (deg/s).

When the third detection unit that detects the position information of the vehicle 100 in the front-rear direction on the drum tester 400 is provided, the travel control unit 208 may control the amount of change in the movement of the vehicle 100 in the front-rear direction and the rate of change in the movement so as not to shift in the front-rear direction (Y-axis direction) on the rollers R1, R2 where the wheels of the vehicle 100 rotate. Movement of the vehicle 100 in the front-rear direction is caused by an acceleration/deceleration operation. Therefore, specifically, the travel control unit 208 controls the acceleration (m/s²) based on the driving force of the accelerator of the vehicle 100 and the deceleration (m/s²) based on the braking force by the brake, as well as the change amount per hour, that is, the acceleration change rate (m/s³) and the deceleration change rate (m/s³).

Here, when the steering operation and the acceleration/deceleration operation are controlled with respect to the vehicle 100 on the drum tester 400 in the same manner as the normal traveling, for example, the wheels of the vehicle 100 are easily separated from the rollers R1, R2 of the drum tester 400, and thus cannot be appropriately controlled. For example, when the steering angle and the acceleration/deceleration of the vehicle 100 on the drum tester 400 are increased in the same manner as in the normal running, the wheels of the vehicle 100 may be separated from the rollers R1, R2 of the drum tester 400.

Therefore, the travel control unit 208 may switch the control mode for the vehicle 100 from the travel control mode to the test control mode when the camera 310 detects that the vehicle 100 reaches the drum tester 400. Here, the travel control mode is a normal control mode for controlling the travel of the vehicle 100 on the road. On the other hand, the test control mode is a special control mode for controlling the operation (traveling) of the vehicle 100 on the drum tester 400.

For example, in the test control mode, the actuator group 120 that drives the vehicle 100 is controlled such that at least one of the amount of change in the movement of the vehicle 100 and the speed of change in the movement is limited as compared with the travel control mode. More specifically, in order to limit the movement of the vehicle 100 in the left-right direction, a possible range of at least one of the steering angle and the steering angle change rate is limited. For example, the upper limit value is decreased. Further, in order to limit the movement of the vehicle 100 in the front-rear direction, a possible range of at least one of an acceleration, an acceleration change rate, a deceleration, and a deceleration change rate is limited. For example, the upper limit value is decreased. In other words, in the test control mode, a possible range of at least one of the steering angle, the steering angle change rate, the acceleration, the acceleration change rate, the deceleration, and the deceleration change rate is limited as compared with the travel control mode. Accordingly, it is possible to suppress the wheels of the vehicles 100 being separated from the rollers R1, R2 of the drum tester 400.

In the test control mode, the control cycle may be set to be shorter than that in the travel control mode. Accordingly, when switching from the travel control mode to the test control mode, the communication frequency between the vehicles 100 and the servers 200 may be switched to a second communication frequency (for example, 5 GHz) higher than the first communication frequency (for example, 2.4 GHz) in the travel control mode. By shortening the control period, it is possible to further suppress the wheels of the vehicles 100 being separated from the rollers R1, R2 of the drum tester 400.

As described above, by switching the control mode for the vehicle 100 on the drum tester 400 from the normal travel control mode to the test control mode, it is possible to suppress the wheels of the vehicle 100 being separated from the rollers R1, R2 of the drum tester 400. As a result, the operation of the vehicle 100 on the drum tester 400 can be appropriately controlled.

Information related to vehicle control (vehicle control information) generated by the travel control unit 208 is transmitted to the vehicle 100 via the communication device 205. In the vehicle 100, the communication device 130 receives the vehicle control information transmitted from the server 200, and the vehicle control device 110 operates the actuator group 120 based on the received vehicle control information to drive the vehicle 100 on the drum tester 400.

On the other hand, the result of the running test of the vehicle 100 on the drum tester 400 is transmitted from the vehicle 100 to the server 200 via the communication device 130. In the server 200, the communication device 205 receives information on the result of the running test from the vehicle 100 or the drum tester 400. The result of the travel test of the vehicle 100 is stored in, for example, the memory 202 together with the travel conditions.

As described above, in the vehicle control system 50 according to the present embodiment, after the camera 310 detects that the vehicle 100 reaches the drum tester 400, the operation of the vehicle 100 on the drum tester 400 is controlled based on the lateral position information on the drum tester 400 of the vehicle 100 detected by the distance sensor 320.

Here, the operation of the vehicle 100 on the drum tester 400 is mainly limited to a lateral slide. Therefore, by detecting lateral movement information of the vehicle 100 on the drum tester 400, the operation of the vehicle 100 on the drum tester 400 can be appropriately controlled.

### A. Travel Control Example 1

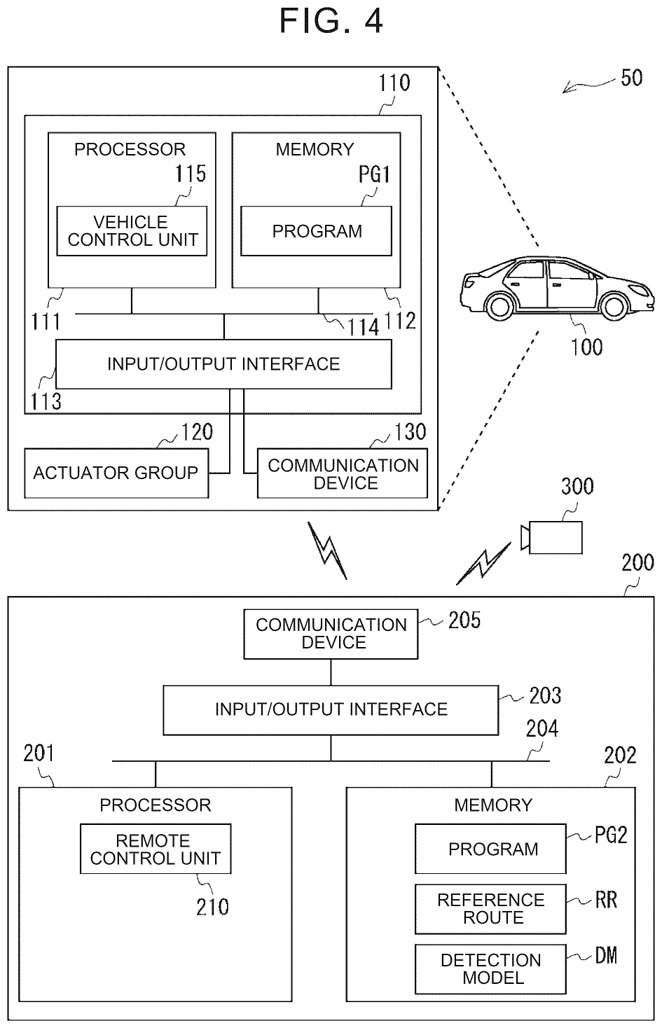

Hereinafter, an example of travel control for controlling travel of the vehicle 100 in the system 50 will be described. FIG. 3 is a conceptual diagram illustrating a configuration of the system 50 in the travel control example 1. The system 50 includes one or more vehicles 100 as a moving object, a server 200, and one or more external sensors 300.

When the moving body is other than the vehicle, the expressions of “vehicle” and “vehicle” in the present disclosure can be appropriately replaced with “moving body”, and the expression of “traveling”can be appropriately replaced with “moving”.

The vehicle 100 is configured to be able to travel by unmanned driving. The term “unmanned driving” means driving that does not depend on the traveling operation of the passenger. The traveling operation means an operation related to at least one of “running”, “turning”, and “stopping” of the vehicle 100. The unmanned driving is realized by automatic or manual remote control using a device located outside the vehicle 100 or by autonomous control of the vehicle 100. A passenger who does not perform the traveling operation may be on the vehicle 100 traveling by the unmanned driving. The passenger who does not perform the traveling operation includes, for example, a person who is simply seated on the seat of the vehicle 100 and a person who performs a work different from the traveling operation such as an assembling operation, an inspection operation, and an operation of switches while riding on the vehicle 100. Driving by the traveling operation of the occupant is sometimes referred to as “manned driving”.

Herein, “remote control” includes “full remote control” in which all of the operations of the vehicle 100 are completely determined from the outside of the vehicle 100, and “partial remote control” in which a part of the operations of the vehicle 100 is determined from the outside of the vehicle 100. Further, “autonomous control” includes “fully autonomous control” in which the vehicle 100 autonomously controls its operation without receiving any information from a device external to the vehicle 100, and “partially autonomous control” in which the vehicle 100 autonomously controls its operation using information received from a device external to the vehicle 100.

In the present embodiment, the system 50 is used in a factory FC that manufactures the vehicles 100. The reference coordinate system of the factory FC is a global coordinate system GC. That is, any position in the factory FC is represented by the coordinates of X, Y, Z in the global coordinate system GC. The factory FC includes a first location PL1 and a second location PL2. The first location PL1 and the second location PL2 are connected by a travel path TR on which the vehicles 100 can travel. In the factory FC, a plurality of external sensors 300 are installed along the travel path TR. The positions of the external sensors 300 in the factory FC are adjusted in advance. The vehicles 100 travel through the travel path TR from the first location PL1 to the second location PL2 by unmanned driving.

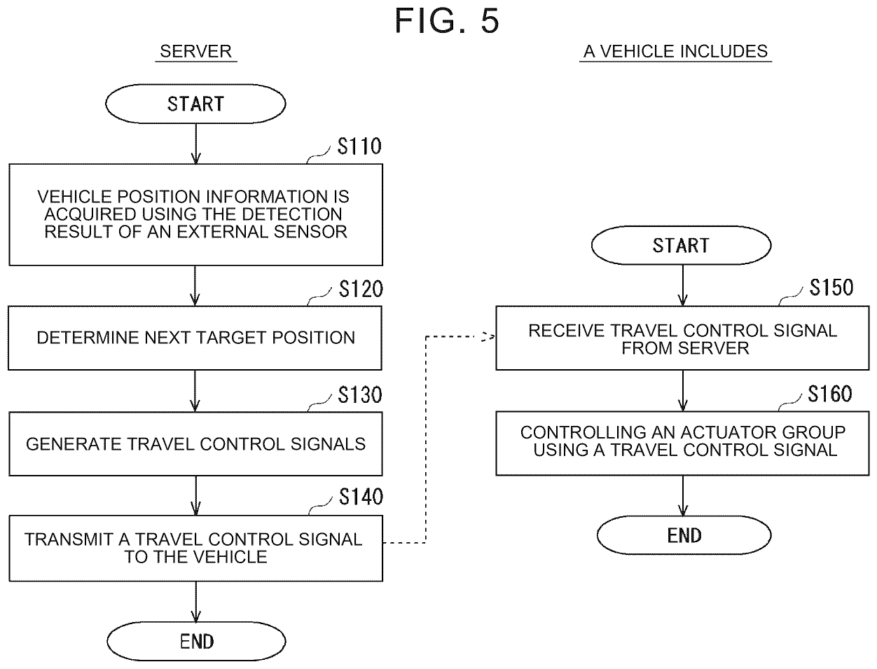

FIG. 4 is a block diagram illustrating a configuration of the system 50. The vehicle 100 includes a vehicle control device 110 for controlling each unit of the vehicle 100, an actuator group 120 including one or more actuators driven under the control of the vehicle control device 110, and a communication device 130 for wirelessly communicating with an external device such as the server 200. The actuator group 120 includes an actuator of a driving device for accelerating the vehicle 100, an actuator of a steering device for changing a traveling direction of the vehicle 100, and an actuator of a braking device for decelerating the vehicle 100.

The vehicle control device 110 includes a computer including a processor 111, a memory 112, an input/output interface 113, and an internal bus 114. The processor 111, the memory 112, and the input/output interface 113 are bidirectionally communicably connected via an internal bus 114. An actuator group 120 and a communication device 130 are connected to the input/output interface 113. The processor 111 executes the program PG1 stored in the memory 112 to realize various functions including functions as the vehicle control unit 115.

The vehicle control unit 115 controls the actuator group 120 to cause the vehicle 100 to travel. The vehicle control unit 115 can cause the vehicle 100 to travel by controlling the actuator group 120 using the travel control signal received from the server 200. The travel control signal is a control signal for causing the vehicle 100 to travel. In the present embodiment, the travel control signal includes the acceleration and the steering angle of the vehicle 100 as parameters. In other embodiments, the travel control signal may include the speed of the vehicle 100 as a parameter in place of or in addition to the acceleration of the vehicle 100.

The server 200 includes a computer including a processor 201, a memory 202, an input/output interface 203, and an internal bus 204. The processor 201, the memory 202, and the input/output interface 203 are bidirectionally communicably connected via an internal bus 204. A communication device 205 for communicating with various devices external to the server 200 is connected to the input/output interface 203. The communication device 205 can communicate with the vehicle 100 by wireless communication, and can communicate with each external sensor 300 by wired communication or wireless communication. The processor 201 implements various functions including functions as the remote control unit 210 by executing the program PG2 stored in the memory 202.

The remote control unit 210 acquires a detection result by the sensor, generates a travel control signal for controlling the actuator group 120 of the vehicle 100 using the detection result, and transmits a travel control signal to the vehicle 100 to cause the vehicle 100 to travel by remote control. That is, the remote control unit 210 includes the functions of the position estimation unit 207 and the travel control unit 208 illustrated in FIG. 2. Further, the remote control unit 210 may generate and output not only the travel control signal but also a control signal for controlling various accessories provided in the vehicle 100 and actuators for operating various kinds of equipment such as a wiper, a power window, and a lamp. That is, the remote control unit 210 may operate the various types of equipment and the various accessories by remote control.

The external sensor 300 is a sensor located outside the vehicle 100. The external sensor 300 in the present embodiment is a sensor that captures the vehicle 100 from the outside of the vehicle 100. The external sensor 300 includes a communication device (not shown), and can communicate with another device such as the server 200 by wired communication or wireless communication.

Specifically, the external sensor 300 is constituted by a camera. The camera as the external sensor 300 captures a captured image including the vehicle 100, and outputs the captured image as a detection result.

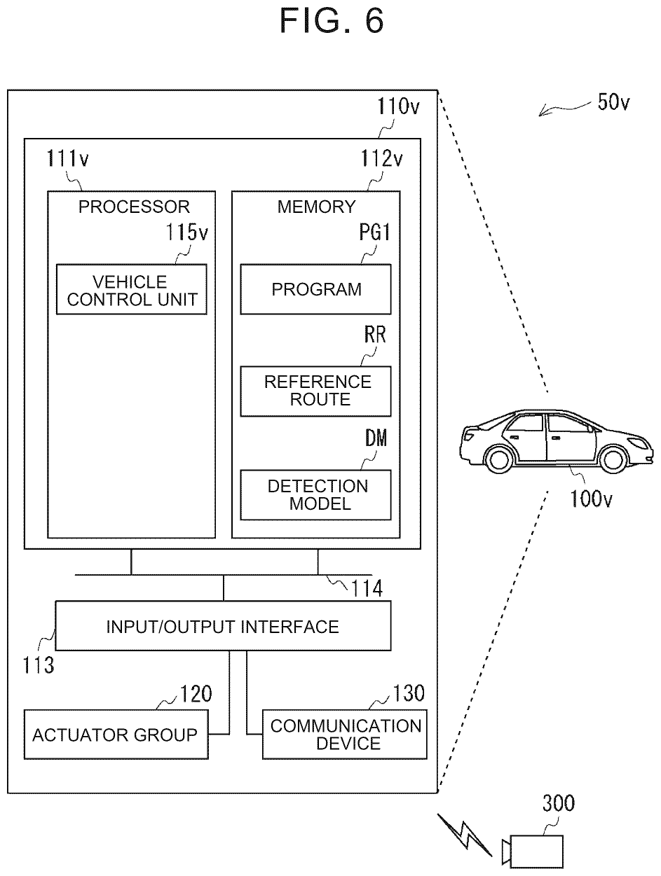

FIG. 5 is a flowchart illustrating a processing procedure of travel control of the vehicle 100 in the travel control example 1. In the process of FIG. 5, the processor 201 of the server 200 functions as the remote control unit 210 by executing the program PG2. The processor 111 of the vehicle 100 functions as the vehicle control unit 115 by executing the program PG1.

In S110, the processor 201 of the server 200 acquires the vehicle position information of the vehicle 100 using the detection result outputted from the external sensor 300. The vehicle position information is position information that is a basis for generating a travel control signal. In the present embodiment, the vehicle position information includes the position and orientation of the vehicle 100 in the global coordinate system GC of the factory FC. Specifically, in S110, the processor 201 acquires vehicle-position data using captured images acquired from cameras that are the external sensors 300.

Specifically, in S110, the processor 201 acquires the position of the vehicle 100 by, for example, detecting the outline of the vehicle 100 from the captured image, calculating the coordinate system of the captured image, that is, the coordinates of the positioning point of the vehicle 100 in the local coordinate system, and converting the calculated coordinates into the coordinates in the global coordinate system GC. The outline of the vehicle 100 included in the captured image can be detected by, for example, inputting the captured image into a detection model DM using artificial intelligence. The detection model DM is prepared in the system 50 or outside the system 50, for example, and stored in the memory 202 of the server 200 in advance. The detection model DM may be, for example, a learned machine learning model learned to implement either semantic segmentation or instance segmentation. As the machine learning model, for example, a convolutional neural network (hereinafter, CNN) learned by supervised learning using a learning dataset can be used. The training data set includes, for example, a plurality of training images including the vehicle 100 and a label indicating which of the regions in the training image indicates the vehicle 100 and the regions other than the vehicle 100. When CNN is learned, the parameters of CNN are preferably updated by back propagation so as to reduce the error between the output-result and-label due to the detection model DM. Further, the processor 201 can obtain the direction of the vehicle 100 by estimating the direction of the movement vector of the vehicle 100 calculated from the position change of the feature point of the vehicle 100 between the frames of the captured image using, for example, the optical flow method.

In S120, the processor 201 of the servers 200 determines the target location to which the vehicles 100 should be heading next. In the present embodiment, the target position is represented by the coordinates of X, Y, Z in the global coordinate system GC. In the memories 202 of the servers 200, reference route RR that is a route on which the vehicles 100 should travel is stored in advance. The route is represented by a node indicating a starting point, a node indicating a passing point, a node indicating a destination, and a link connecting the respective nodes. The processor 201 uses the vehicle position information and the reference route RR to determine the target position to which the vehicle 100 is to be directed next. The processor 201 determines the target position on the reference route RR ahead of the current position of the vehicles 100.

In S130, the processor 201 of the server 200 generates a travel control signal for causing the vehicle 100 to travel toward the determined target position. The processor 201 calculates the traveling speed of the vehicle 100 from the transition of the position of the vehicle 100, and compares the calculated traveling speed with the target speed. The processor 201 generally determines the acceleration so that the vehicle 100 accelerates when the travel speed is lower than the target speed, and determines the acceleration so that the vehicle 100 decelerates when the travel speed is higher than the target speed. Further, when the vehicle 100 is located on the reference route RR, the processor 201 determines the steering angle and the acceleration so that the vehicle 100 does not deviate from the reference route RR. When the vehicle 100 is not located on the reference route RR, in other words, when the vehicle 100 deviates from the reference route RR, the processor 201 determines the steering angle and the acceleration so that the vehicle 100 returns to the reference route RR.

In S140, the processor 201 of the servers 200 transmits the generated travel control signal to the vehicles 100. The processor 201 repeats the acquisition of the position of the vehicle 100, the determination of the target position, the generation of the travel control signal, the transmission of the travel control signal, and the like at predetermined intervals.

In S150, the processor 111 of the vehicle 100 receives the travel control signal transmitted from the server 200. In S160, the processor 111 of the vehicle 100 controls the actuator group 120 using the received travel control signal, thereby causing the vehicle 100 to travel at the acceleration and the steering angle represented by the travel control signal. The processor 111 repeatedly receives the travel control signal and controls the actuator group 120 at a predetermined cycle. According to the system 50 in the present example, the vehicle 100 can be driven by remote control, and the vehicle 100 can be moved without using a conveyance facility such as a crane or a conveyor.

### B: Travel Control Example 2

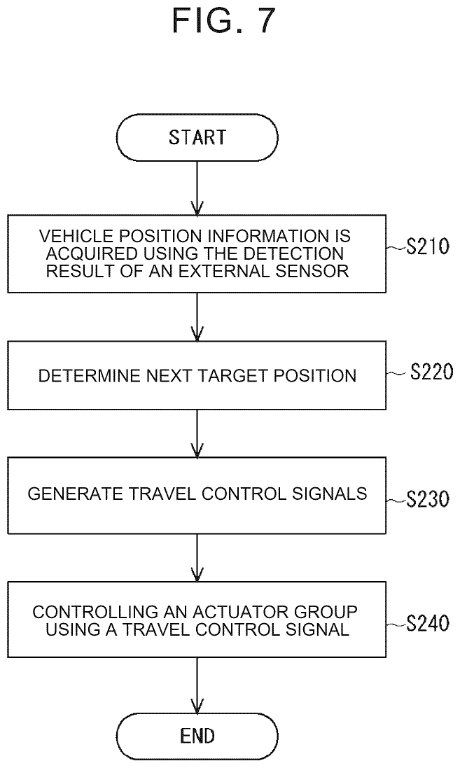

FIG. 6 is an explanatory diagram illustrating a schematic configuration of a 50v according to a second exemplary travel control. In the present example, 50v differs from the travel control example 1 in that it does not include the servers 200. In addition, the vehicle 100v in the configuration can travel by autonomous control of the vehicle 100v. Other configurations are the same as described above unless otherwise specified.

In the present embodiment, the processor 111v of the vehicle control device 110v functions as the vehicle control unit 115v by executing the program PG1 stored in the memory 112v. The vehicle control unit 115v can cause the vehicle 100v to travel by autonomous control by acquiring an output result from the sensor, generating a travel control signal using the output result, and outputting the generated travel control signal to operate the actuator group 120. In the present embodiment, in addition to the program PG1, the detection model DM and the reference route RR are stored in advance in the memory 112v.

FIG. 7 is a flowchart showing a process sequence of the travel control of the vehicle 100v in the travel control example 2. In the process of FIG. 7, the processor 111v of the vehicle 100v functions as the vehicle control unit 115v by executing the program PG1.

In S210, the processor 111v of the vehicle control device 110v acquires the vehicle position information using the detection result outputted from the camera as the external sensor 300. In S220, the processor 111v determines the target position to which the vehicle 100v should be headed next. In S230, the processor 111v generates a travel control signal for causing the vehicle 100v to travel toward the determined target position. In S240, the processor 111v controls the actuator group 120 by using the generated travel control signal, thereby causing the vehicle 100v to travel in accordance with the parameter represented by the travel control signal. The processor 111v repeats acquiring the vehicle position information, determining the target position, generating the travel control signal, and controlling the actuator group at a predetermined cycle. According to the system 50v of the present embodiment, the vehicle 100v can be driven by the autonomous control of the vehicle 100v without remotely controlling the vehicle 100v by the servers 200.

### YY: Other Driving Control Examples

### YY1

In the above example, the external sensor 300 is a camera. On the other hand, the external sensor 300 may not be a camera, and may be, for example, a LiDAR (Light Detection And Ranging). In this case, the detection result output by the external sensor 300 may be three-dimensional point cloud data representing the vehicle 100. In this case, the server 200 or the vehicle 100 may acquire the vehicle position information by template matching using three-dimensional point cloud data as a detection result and reference point cloud data prepared in advance.

### YY2

In the travel control example 1, the server 200 executes processing from acquisition of vehicle position information to generation of a traveling control signal. On the other hand, at least a part of the processing from the acquisition of the vehicle position information to the generation of the travel control signal may be executed by the vehicle 100. For example, the following forms (1) to (3) may be used.
(1) The server 200 may acquire the vehicle position information, determine a target position to which the vehicle 100 should be heading next, and generate a route from the current position of the vehicle 100 represented by the acquired vehicle position information to the target position. The server 200 may generate a route to a target position between the current location and the destination, or may generate a route to the destination. The server 200 may transmit the generated route to the vehicle 100. The vehicle 100 may generate a travel control signal so that the vehicle 100 travels on the route received from the server 200, and control the actuator group 120 using the generated travel control signal.
(2) The server 200 may acquire the vehicle position information and transmit the acquired vehicle position information to the vehicle 100. The vehicle 100 may determine a target position to which the vehicle 100 should be heading next, and generate a route from the current position of the vehicle 100 to the target position represented by the received vehicle position information. The vehicle 100 may generate a travel control signal so that the vehicle 100 travels on the generated route, and control the actuator group 120 using the generated travel control signal.
(3) In the above embodiments (1) and (2), an internal sensor may be mounted on the vehicle 100, and a detection result output from the internal sensor may be used for at least one of generation of a route and generation of a travel control signal. The internal sensor is a sensor mounted on the vehicle 100. The internal sensor may include, for example, a sensor that detects a motion state of the vehicle 100, a sensor that detects an operation state of each unit of the vehicle 100, and a sensor that detects an environment around the vehicle 100. Specifically, the inner sensor may include, for example, a camera, a LiDAR, a millimeter-wave radar, an ultrasonic sensor, a GPS sensor, an accelerometer, a gyroscope, and the like. For example, in the embodiment (1), the server 200 may acquire the detection result of the internal sensor and reflect the detection result of the internal sensor in the path when generating the path. In the aspect (1), the vehicle 100 may acquire the detection result of the internal sensor and reflect the detection result of the internal sensor in the travel control signal when generating the travel control signal. In the aspect (2), the vehicle 100 may acquire the detection result of the internal sensor and reflect the detection result of the internal sensor in the path when generating the path. In the aspect (2), the vehicle 100 may acquire the detection result of the internal sensor and reflect the detection result of the internal sensor in the travel control signal when generating the travel control signal.

### YY3

In the travel control example 2, an internal sensor may be mounted on the vehicle 100v, and a detection result outputted from the internal sensor may be used for at least one of generation of a route and generation of a traveling control signal. For example, the vehicle 100v may acquire the detection result of the internal sensor and reflect the detection result of the internal sensor in the route when generating the route. The vehicle 100v may acquire the detection result of the internal sensor and reflect the detection result of the internal sensor in the travel control signal when generating the travel control signal.

### YY4

In the travel control example 2, the vehicle 100v acquires the vehicle position information using the detection result of the external sensor 300. On the other hand, an inner sensor is mounted on the vehicle 100v. The vehicle 100v may acquire the vehicle position information using the detection result of the internal sensor, determine a target position to which the vehicle 100v should be directed next, and generate a route from the current position of the vehicle 100v represented by the acquired vehicle position information to the target position. The vehicle 100v may generate a travel control signal for traveling on the generated route, and control the actuator group 120 using the generated travel control signal. In this case, the vehicle 100v can travel without using the detection result of the external sensor 300 at all. The vehicle 100v may acquire the target arrival time and the traffic jam information from the outside of the vehicle 100v and reflect the target arrival time and the traffic jam information on at least one of the route and the travel control signal. In addition, all the functional configurations of the system 50v may be provided in the vehicle 100v. That is, the process implemented by the system 50v may be implemented by the vehicle 100v alone.

### YY5

In the travel control example 1, the server 200 automatically generates a traveling control signal to be transmitted to the vehicle 100. On the other hand, the server 200 may generate a travel control signal to be transmitted to the vehicle 100 in accordance with an operation of an external operator located outside the vehicle 100. For example, an external operator may operate a control device including a display for displaying a captured image output from the external sensor 300, a steering for remotely controlling the vehicle 100, an accelerator pedal, a brake pedal, and a communication device for communicating with the server 200 through wired communication or wireless communication, and the server 200 may generate a travel control signal corresponding to an operation applied to the control device.

### YY6

In each of the above-described travel control examples, the vehicle 100 may have a configuration that can be moved by unmanned driving, and may be, for example, in the form of a platform having a configuration described below. Specifically, the vehicle 100 may include at least the vehicle control device 110 and the actuator group 120 in order to perform three functions of “running,” “turning,” and “stopping” by unmanned driving. When the vehicle 100 acquires information from the outside for unmanned driving, the vehicle 100 may further include a communication device 130. That is, the vehicle 100 that can be moved by the unmanned driving may not be equipped with at least a part of an interior component such as a driver's seat or a dashboard. In the vehicle 100 that can be moved by unmanned driving, at least a part of an exterior component such as a bumper or a fender may not be attached, and the body shell may not be attached. In this instance, the remaining components, such as the body shell, may be mounted to the vehicle 100 until the vehicle 100 is shipped from the factory FC. The remaining components, such as the body shell, may be mounted to the vehicle 100 after the vehicle 100 is shipped from the factory FC with the remaining components, such as the body shell, not being mounted to the vehicle 100. Each of the components may be mounted from any direction, such as the upper side, lower side, front side, rear side, right side or left side of the vehicle 100, each may be mounted from the same direction, or may be mounted from a different direction. It should be noted that the position determination can also be performed for the form of the platform in the same manner as the vehicle 100 according to the first embodiment.

### YY7

The vehicle 100 may be manufactured by combining a plurality of modules. The module means a unit composed of a plurality of components arranged in accordance with a part or a function of the vehicle 100. For example, the platform of the vehicle 100 may be manufactured by combining a front module that constitutes a front portion of the platform, a central module that constitutes a central portion of the platform, and a rear module that constitutes a rear portion of the platform. The number of modules constituting the platform is not limited to three, and may be two or less or four or more. In addition to or instead of the components constituting the platform, the components constituting a part of the vehicle 100 different from the platform may be modularized. Further, the various modules may include any exterior parts such as bumpers and grills, and any interior parts such as sheets and consoles. In addition, not only the vehicle 100 but also a moving object of an arbitrary mode may be manufactured by combining a plurality of modules. Such a module may be manufactured, for example, by joining a plurality of parts by welding, a fixture, or the like, or may be manufactured by integrally molding at least a part of the parts constituting the module as one part by casting. Molding techniques for integrally molding one part, in particular a relatively large part, are also called gigacasts or megacasts. For example, the front module, the central module, and the rear module described above may be manufactured using gigacast.

### YY8

Transporting the vehicle 100 by using the traveling of the vehicle 100 by the unmanned driving is also referred to as “self-propelled conveyance”. A configuration for realizing self-propelled conveyance is also referred to as a “vehicle remote control autonomous driving conveyance system”. Further, a production method of producing the vehicle 100 by using self-propelled conveyance is also referred to as “self-propelled production”. In self-propelled manufacturing, for example, at least a part of conveyance of the vehicle 100 is realized by self-propelled conveyance in a factory FC that manufactures the vehicle 100.

### YY9

In each of the above-described travel control examples, some or all of the functions and processes implemented in software may be implemented in hardware. In addition, some or all of the functions and processes implemented in hardware may be implemented in software. For example, various circuits such as an integrated circuit and a discrete circuit may be used as hardware for realizing various functions in the above-described embodiments.

Note that the present disclosure can be realized by causing a computer program to be executed by a CPU (Central Processing Unit) in part or all of the processes in the external sensor 300, the vehicles 100, the servers 200, and the like described above.

The programs described above include instructions (or software code) that, when loaded into a computer, cause the computer to perform one or more of the functions described in the embodiments. The program may be stored in a non-transitory computer-readable medium or a tangible storage medium. By way of example, and not limitation, computer-readable media or tangible storage media include RAM (Random-Access Memory), ROM (Read-Only Memory), and flash memory. Computer-readable media or tangible storage media include SSD (Solid-State Drive) or another memory-technology, CD-ROM, DVD (Digital Versatile Disc). Computer-readable media or tangible storage media include Blu-ray disks or other optical disk storage, magnetic cassettes, magnetic tape, magnetic disk storage, or other magnetic storage devices. The program may be transmitted on a transitory computer readable medium or a communication medium. By way of example, and not limitation, transitory computer-readable media or communication media include electrical, optical, acoustic, or other forms of propagated signals.

Although the present disclosure has been described with reference to the embodiments, the present disclosure is not limited to the above-described embodiments. Various changes that can be understood by a person skilled in the art within the scope of the present disclosure can be made to the configuration and details of the present disclosure. Each embodiment can be combined with other embodiments as appropriate.

What is claimed is:

1. A vehicle control system that causes a vehicle to travel autonomously to a drum tester and controls operation of the vehicle on the drum tester, the vehicle control system comprising:
a first detection unit that detects that a target vehicle has reached the drum tester;
a second detection unit that detects movement information on lateral movement of the target vehicle on the drum tester; and
a controller that controls travel of the target vehicle to the drum tester and operation of the target vehicle on the drum tester, wherein the controller controls the operation of the target vehicle on the drum tester based on the movement information detected by the second detection unit after the first detection unit detects that the target vehicle has reached the drum tester.

2. The vehicle control system according to claim 1, wherein the first detection unit also serves as the second detection unit.

3. The vehicle control system according to claim 1, wherein:
the controller
switches a control mode for the target vehicle from a travel control mode to a test control mode for controlling the operation on the drum tester when the first detection unit detects that the target vehicle has reached the drum tester, and
controls the operation of the target vehicle on the drum tester based on the movement information detected by the second detection unit in the test control mode; and
an actuator that drives the vehicle is controlled such that at least one of a change amount and a change speed of movement of the vehicle is limited in the test control mode as compared with the travel control mode.

4. The vehicle control system according to claim 3, wherein a control cycle is set to be shorter in the test control mode than in the travel control mode.

5. The vehicle control system according to claim 4, wherein:
the controller is wirelessly connected to the target vehicle; and
switching is made to a second communication frequency higher than a first communication frequency in the travel control mode when switching is made from the travel control mode to the test control mode.
